(19) United States
(12) Patent Application Publication
(10) Pub. No.: US 2006/0279404 A1
(43) Pub. Date: Dec. 14, 2006

(54) Distribution System and Implement for Subscribed and Voiced Publications

(76) Inventor: Yi Wu, Calabasas, CA (US)

Correspondence Address: YI WU, 3925 N. CEANOTHUS PLACE, APT. K, CALABASAS, CA, 91302, US

(21) Appl. No.: 11/160,100

(22) Filed: Jun. 9, 2005

(51) Int. Cl. G08B 5/22

(52) U.S. Cl. 340/7.46; 340/7.43; 340/7.57; 340/7.55; 340/7.48

(57) ABSTRACT

A method and system of distributing massive voiced publications to individual subscribers is described; The distribution system is constructed by: a transmission system including encoders, amplifiers, FM transmitters and other necessary equipments; some receiver devices; each receiver device has a unique identification number, a decoder and a saving unit that can automatically save the publications to a physical memory or a hard disk. The transmission system broadcasts massive voiced publications with identification numbers together; Amount of identification numbers of receiver devices can be up to millions or just one only; Receiver devices individually receive, decode and save the subscribed publications automatically.

The present invention relates to a method or a system that can distribute the voiced publications or/and other subscribed publications to individual users or a group of users directly.

Radio broadcasting used to be a major media, but one of disadvantages is that the program for listeners cannot be indexed and replaying the program by listeners is not easy. Newspaper is another kind of major media, but the print and distribution of newspapers needs large numbers of manpower. The object of present invention is to provide a method or system that can distribute massive subscribed publications to individual users by radio broadcasting. Users can receive subscribed publications by receiver devices with unique identification numbers, and they can select and replay subscribed publications anytime and anywhere.

A distribution system of the present invention includes two parts, a transmission system and receiver devices.

The transmission system includes encoders, amplifiers, one or several transmission devices and other equipments. The transmission devices can be a FM transmission station or similar station for broadcasting subscribed publications with identification numbers of receiver devices. Amount of identification numbers can be up to millions or just one only.

Such a transmission system gets the electronic and digital publications from publishers through networks, and encodes the publications with identification numbers of receiver devices, the owner of that subscribe the publications, into a data stream. Then, the transmission system processes the data stream, amplifies it and sends it the FM transmitter. The transmitter broadcasts the data stream in the air.

Such a transmission device of the present invention may further comprise communication satellite systems, so that publications can be distributed worldwide.

A receiver device of the present invention can receive the data stream in the air, decode the data stream into some digital files and save the files to one or several folders in a physical memory or a hard disk. And the device should usually be a voice player, such as a MP3 player. Furthermore, the device can be with an image viewer, too.

Such a receiver device has one unique identification code, so that the device can receive the publications that exactly subscribed.

Such a receiver device of the present invention may further comprise functionalities controlled by software and a signal sent by the transmission system. When a receiver device lost or stolen the owner of it can disable all the functions through the service group until the owner resume it again.

The publications hereto mentioned mostly are in some sound formats, such as MP3 format or other formats. They also can associate with other files in text formats or image formats. These publications can be regular periodicals, books, radio recordings, songs, music or other publications.

The features and advantages of the present invention will become apparent from the following detailed description of preferred embodiments which, taken in conjunction with the accompanying drawings, illustrates the principles of the invention.

### BRIEF DESCRIPTION OF THE DRAWINGS

FIG. 1 illustrates a distribution system for subscribed publications.

FIG. 2 illustrates an example of the structure of folders that such a receiver device would receive and save them in a memory or a hard disk.

### DETAILED DESCRIPTION OF THE PREFERRED EMBODIMENTS

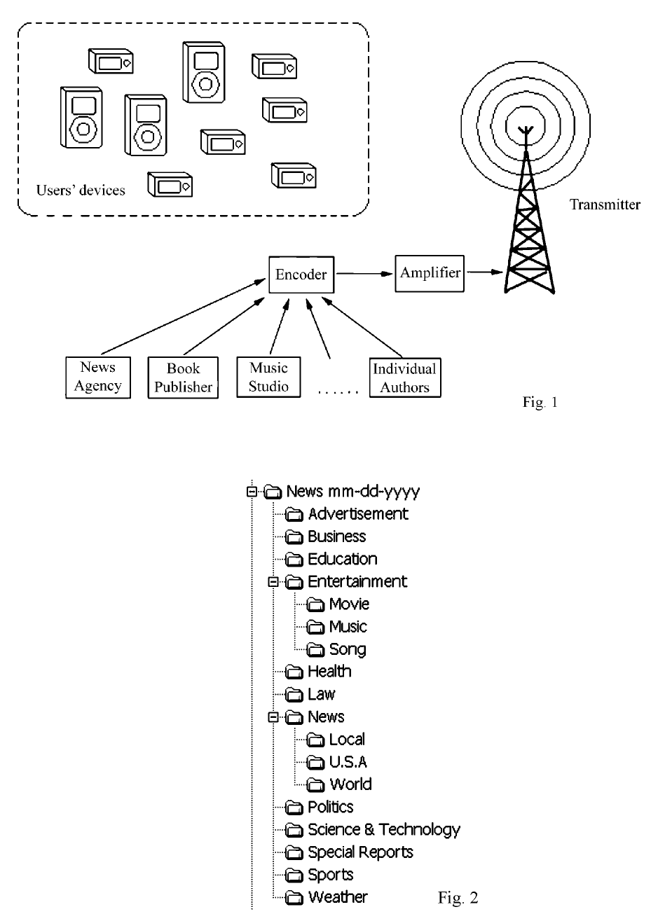

Referring to the drawing, FIG. 1 shows such a system for the subscribe publications. There are three parts in FIG. 1, publishers, users and a distribution system for voiced publications.

Users, who have such receiver devices, individually subscribe some publications, such as voiced newspapers, by providing their identification numbers of the receiver devices. Users can choose the preference when they subscribe the publications. For example: receiving advertisements, not receiving advertisements, or just receiving local advertisements.

The publishers of newspapers or/and books will send the electronic files (e-files) to the transmission system by networks according to the orders of users with unique identification numbers of receiver devices. After encoding, amplifying and other processing the transmission system broadcasts the electronic files with one or a group of identification numbers of receiver devices in the air. When a receiver device powers on, such a receiver device would check messages received. If the receiver device finds an identification number matching its own identification number, the receiver device would automatically receive, decode and save electronic files to one or some folders in a physical memory or a hard disk according to the original structure from publishers. An example of such a structure is illustrated in FIG. 2. Every folder has one or more sound files of the voiced publications that can be indexed. After receiving users can select the voiced files of news or books according to his/her favorite and listen them anytime and anywhere. The name of every folder can be associated with a sound file of the name. It is convenient that when the folder is selected the sound file of this folder name will tell users which is selected. The users can transfer the files to personal computers, too.

In an alternative embodiment, a receiver device can be divided into two parts. One is a docking cradle that can receive the data stream in the air, decode the data stream and save the voiced files in a memory. The docking cradle can be, but must not be, connected to a computer. The other is a player unit, such as an MP3 Player that is widely in use without the decoder or/and receiving part currently. When the player unit is connected with the docking cradle, the subscribed publications can be transferred to the player unit automatically. At the same time battery of the player unit can be recharged.

From the foregoing it will be apparent the embodiments of the present invention provide for an advantageous and effective method of distribute large mount of voiced publications to individual users. Although the specific embodiments of the present invention have been described in detail, the invention is not limited to the examples so described and illustrated. And it should be understood that various modifications and changes may be made without departing from the scope of the present invention.

What is claimed is:

1. A system for distributing large numbers of subscribed publications to individual users, comprising:
a FM/AM transmission system to broadcast subscribed publications in the air;
receiver devices with unique identification numbers to receive, decode and save the subscribed publications in their physical memory or hard disks automatically; and
said receiver devices can replay the voiced publications and transform the publications to a personal computer system.

2. A method for distributing large numbers of subscribed publications, said method including the steps of:
encoding the publications with identification numbers into a data stream according to the protocol between the transmission system and receiver devices;
broadcasting the data stream in the air by FM/AM transmitter, after necessary processing of amplifying and so on;
receiver devices distinguishing the data stream of subscribed publications by their unique identification numbers and receiving the data stream;
the receiver devices decoding the data stream and convert it into files of publications, and saving the files of publications in their physical memory or hard disks automatically.

3. A transmission system as set forth in claim 1, wherein the encoder can convert the files of subscribed publications with identification numbers of receiver devices into a data stream; the amount of identification numbers can be one only or up to millions, even more.

4. A system for distributing subscribed voiced publications as in claim 1, wherein receiver devices are constructed; every receiver device has its unique identification number that is permanently saved in it.

5. A receiver device as set forth in claim 4, wherein the receiver device can distinguish the data stream of subscribed publications by its unique identification number.

6. A receiver device as set forth in claim 4, wherein the receiver device can decode the data stream and convert it into the files of subscribed publications.

7. A receiver device as set forth in claim 4, wherein the receiver device can save the files of subscribed publications in a physical memory or a hard disk automatically.

8. A receiver device as set forth in claim 4, wherein the receiver device may further comprise functionalities controlled by a signal sent by the transmission system. When a receiver device lost or stolen the owner of it can disable all the functions through a service group until the owner resume it again.

9. A receiver device as set forth in claim 4, wherein the receiver device can be separated into two parts, a docking cradle and a player.

10. A docking cradle as set forth in claim 9, wherein the docking cradle can have any feature as set forth in claim 5, 6, and 7.
